(19) United States
(12) Patent Application Publication
(10) Pub. No.: US 2014/0016333 A1
(43) Pub. Date: Jan. 16, 2014

(54) MODULAR FIXTURE SYSTEM

(71) Applicant: Scott S. YU, Tiburon, CA (US)

(72) Inventor: Scott S. YU, Tiburon, CA (US)

(21) Appl. No.: 13/940,837

(22) Filed: Jul. 12, 2013

Related U.S. Application Data
(60) Provisional application No. 61/671,008, filed on Jul. 12, 2012.

(51) Int. Cl. F21V 21/096

(52) U.S. Cl. CPC F21V 21/096
USPC 362/382; 29/428; 248/206.5

(57) ABSTRACT

A device comprising a mounting portion, said mounting portion having a substantially flat surface and a receiver portion, said receiver portion integrally formed with said mounting portion and having a predetermined height and depth. The device includes at least one magnet disposed on said receiver portion such that a fixture having a portion of substantially equal height and depth as the receiver portion, said fixture comprised of at least a portion of ferromagnetic material may be inserted and held securely in place by the receiver. Some embodiments include a fastening means on the mounting portion. The fixture may be a luminaire.

### PRIORITY

This application claims the benefit of co-pending provisional patent application 61/671,008 entitled “Modular Fixture System,” filed on Jul. 12, 2012 by the same inventor which is incorporated into this document by reference as if fully set forth herein.

### BACKGROUND

The present invention relates generally to lighting systems, and more particularly to a modularized fixture system for providing easy to install and affordable lights, power and communications media in certain environments.

### SUMMARY

Disclosed herein is a device comprising a mounting portion, said mounting portion having a substantially flat surface and a receiver portion, said receiver portion integrally formed with said mounting portion and having a predetermined height and depth. The device includes at least one magnet disposed on said receiver portion such that a fixture having a portion of substantially equal height and depth as the receiver portion, said fixture comprised of at least a portion of ferromagnetic material may be inserted and held securely in place by the receiver. Some embodiments include a fastening means on the mounting portion. The fixture may be a luminaire.

The construction and method of operation of the invention, however, together with additional objectives and advantages thereof will be best understood from the following description of specific embodiments when read in connection with the accompanying drawings

### BRIEF DESCRIPTION OF THE DRAWINGS

FIG. 1 illustrates certain fixtures 110 which may include a luminaire.

FIG. 2 shows a perspective view of an embodiment according to the current disclosure.

FIG. 3 shows a reverse view of a fixture mount with a fixture 310 inserted in place.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### Detail Description

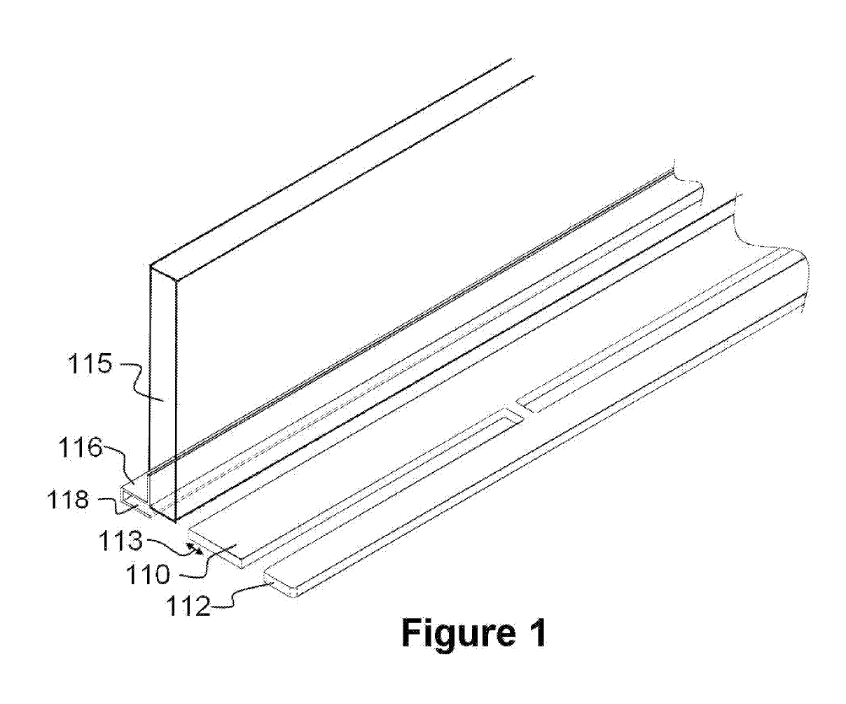

FIG. 1 illustrates an embodiment of a fixture mount 116 which may include a luminaire. In some embodiments the fixture 110 may be a chassis operable for mounting incandescent luminaries, LED luminaires, power receptacle, digital communications ports, USB ports, Ethernet ports and the like. The fixture 110 has a predetermined height 112 and a portion of the width is reserved for mounting 113.

A fixture mount 116 is formed for attachment to a support structure 115 (shown as translucent). The support structure 115 may be a part of a modular office such as those in office cubicles, an overhead or wall attachment or the like. In some embodiments the fixture mount 116 may provide a mounting surface for attachment to the support structure 115. The mounting surface may be relatively thin to allow for mudding the mounting surface to a wall.

The fixture 110 is operable to slide into an aperture (or receiver) 118 of fixture mount 116 formed such that the portion 113 is encompassed by the aperture 118. One having skill in the art will appreciate that the aperture 118 is sized to fit the height 112 and the width 113 of the fixture 110. The fixture mount 116 may be made from any material that can handle the load stresses imposed by the fixture 110. In some embodiments the fixture mount 116 may be formed from extruded aluminum. Other embodiments may use spring steel, injection molded plastic, and the like.

The receiver 118 is formed as a narrow elongated opening of the same single material as the fixture mount 116, thus allowing for low cot manufacturing. However, this application should not be read as limiting the disclosure to only a single material. Likewise the fixture 110 is shown as a single, narrow, elongated device but this disclosure should not be limited in that way. Different shaped fixtures and receivers may be employed in some embodiment.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

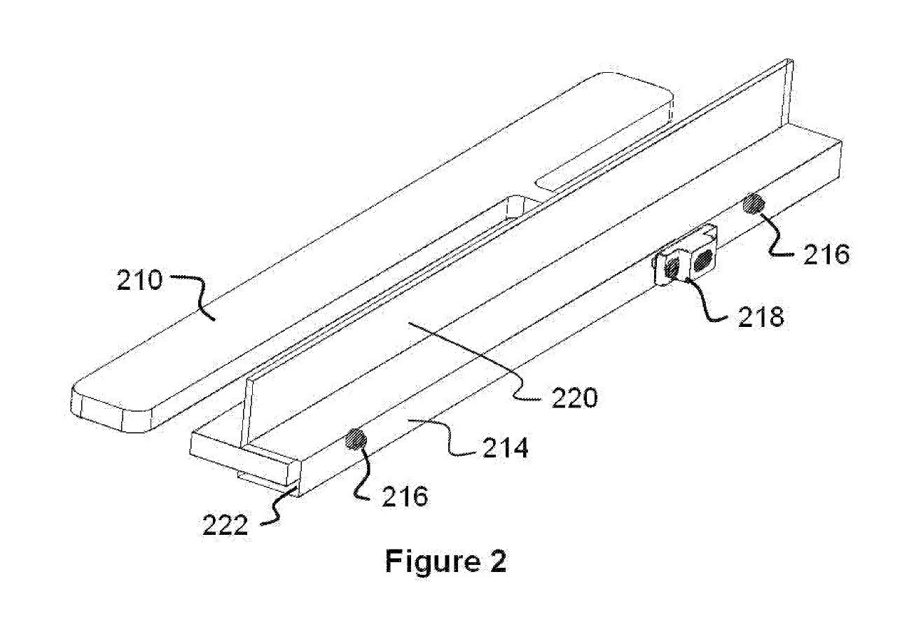

FIG. 2 shows a perspective view of an embodiment according to the current disclosure. In FIG. 2 a fixture mount 214 includes one or more magnets 216 disposed on or into the receiver 222 portion of the fixture mount 214. If a support structure (not shown) is formed from magnetic material, then the magnets 216 may be physically attached using magnetism. In certain embodiments, the magnets 216 may be disposed in openings on the fixture mount 214, or otherwise embedded into the material to provide sufficient holding power during operation.

The fixture mount 214 includes a mounting surface 220 which may include fasters, threaded holes, studs and the like (not shown). The receiver 222 is operable to hold a fixture 210 by having the receiver dimensions closely match the fixture dimensions such that the fixture 210 may fit snugly into the receiver 222. One having skill in the art will appreciate that if the fixture 210 is made from ferromagnetic material, the fixture 210 may be held in position using magnetism.

The fixture mount 214 may include a receptacle 218 for providing electrical power, digital signals and the like to a fixture 210. One having skill in the art will recognize that the type of receptacle 218 used is a function of the purpose of the fixtures 210. The fixture 210 may provide for springing electrical contracts such that placing the fixture 210 into the fixture mount 214 provides sufficient electrical conductivity. Alternatively the fixture 210 may be formed such that the receptacle 220 extends through an opening in the fixture mount 214 such that sliding a fixture into the fixture mount 214 allows alignment of an opening (not shown) on the fixture mount 214 with the receptacle 218.

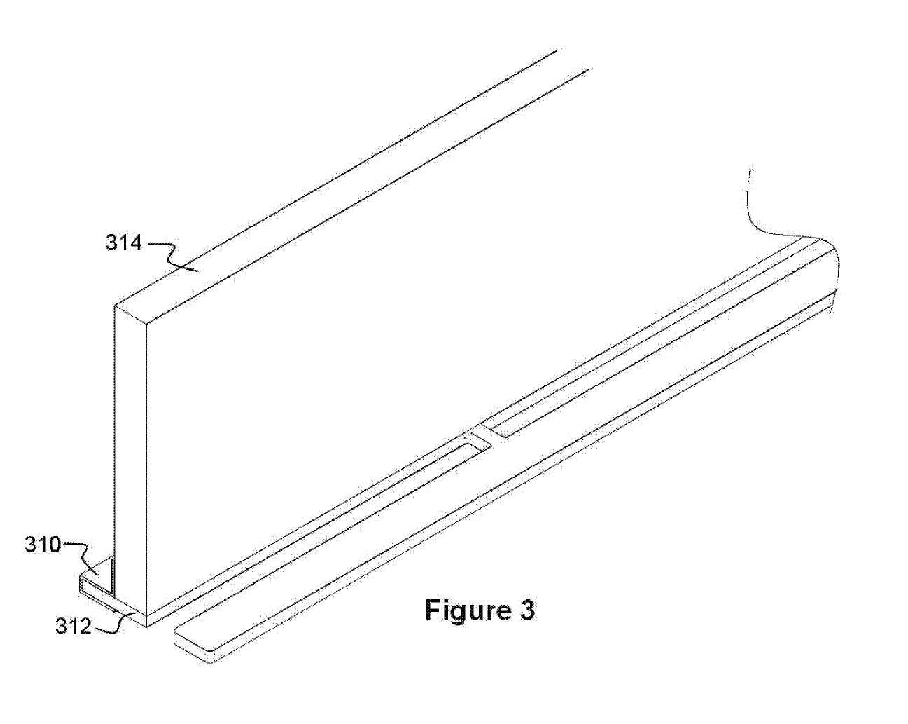

FIG. 3 shows a reverse view of a fixture mount 310 with a fixture 312 inserted in place. In FIG. 3 the fixture mount 310 is affixed to a support 314. The fixture mount 310 is formed with a channel sized to receive a fixture 213. The channel proved a snug fit by forming the channel in a manner that “pinch fits” the width and depth of the fixture 312.

In some embodiments the fixture 312 may be used to “fix” tools or other hardware into position. For example and without limitation light sources, occupancy sensors, digital connections and the like.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims.

What is claimed:

1. A device comprising:
a mounting portion, said mounting portion having a substantially flat surface;
a receiver portion, said receiver portion integrally formed with said mounting portion and having a predetermined height and depth;
at least one magnet disposed on said receiver portion;
a fixture, said fixture having a portion of substantially equal height and depth as the receiver portion, said fixture comprised of at least a portion of ferromagnetic material.

2. The device of claim 1 wherein the mounting portion include at least one fastener.

3. The device of claim 1 wherein the mounting portion include at least one through hole.

4. The device of claim 1 wherein the fixture is a luminaire.

5. A method comprising:
attaching a fixture support to a surface, said fixture support including a receiver portion, said receiver portion having a predetermined height and depth, and
inserting a fixture into the receiver portion, said fixture having a portion substantially the same height and depth as the receiver portion.

6. The method of claim 5 wherein the fixture is a luminaire.
